(19) United States
(12) Patent Application Publication
(10) Pub. No.: US 2010/0191790 A1
(43) Pub. Date: Jul. 29, 2010

(54) SYSTEM AND METHOD FOR CORRELATION SCORING OF SIGNALS

(75) Inventor: Robert H. Kincaid, Half Moon Bay, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Loveland, CO (US)

(21) Appl. No.: 12/362,294

(22) Filed: Jan. 29, 2009

(51) Int. Cl. G06F 1/02; G06F 17/15

(52) U.S. Cl. 708/274; 708/424

(57) ABSTRACT

Systems, methods and computer readable storage media are provided for identifying, in a signal of interest, signal segments matching a reference signal segment. A processor coupled to memory is adapted to perform operations including: converting the reference signal segment to a first vector characterized by n pairs of data points, wherein n is an integer greater than zero and each pair of data points comprises a data point having a value along the first axis and a value along a second axis normal to the first axis. Segment of the signal of interest are converted to additional vectors, wherein each of the segments of the signal of interest has a first length in a direction along the first axis and has n pairs of data points. A correlation value is calculated between the reference signal segment and each of the segments of the signal of interest, using the first vector and the additional vectors, respectively. An estimation of the magnitude of the reference signal segment relative to at least a subset of the segments of the signal of interest for which correlation values have indicated relatively similar correlation is calculated.

### BACKGROUND OF THE INVENTION

There are many applications of signal processing where it is desired to find one or more signals or signal segments that match a reference signal or signal segment. Generally, previous solutions rely upon computing some type of similarity between a reference signal and a putative matching signal to determine a measure of relative similarity between the signals. Similarity measures that are often used include Euclidean distance measurement and Pearson Correlation measurement.

When using Euclidean distance measurement, the computed distance measurement value is highly dependent upon the data being processed and no specific value for a threshold can be determined a priori as to what constitutes a distance close enough to conclude that the signals being measured are considered to be “similar”. Thus, the user employing the Euclidean distance measurement technique must, for each set of data, decide on a threshold Euclidean distance measurement score that is to be considered indicative of sufficient similarity. Euclidean distance focuses more on similarity of magnitudes of the signals being compared but ignores comparison of shapes of the signals (i.e., waveforms). Still further, Euclidean distance measurements are not readily amenable to statistical analysis.

The Pearson Correlation measurement technique has an advantage relative to Euclidean distance measurement, in the Pearson Correlation provides scores that always vary between −1 and +1 and therefore these scores have a well-understood interpretation. Generally, values greater than about 0.9 indicate a very good correlation between the signals measured, wherein the closer the value is to +1 the stronger is the indicated correlation. However, this threshold is also arbitrary and may be modified according to the data it is applied to, as well as expert knowledge of the user.

Other types of correlation may be used, such as the Spearman rank correlation. However, this is a rank-based method, and this, as well as other rank-based methods are less sensitive to the overall shape of the signals, compared to those measures described above.

Although Pearson Correlation measurements measure the similarity in signal shape between the signals, this technique does not consider the relative magnitudes of the signals being compared. For many applications, it is useful to know not only whether signals have the same or similar shape, but also whether the signals have a similar (or distinctly different) magnitudes.

Accordingly there is a continuing need for improved correlation scoring techniques to determine not only similarity among shapes of signals, but to also compare relative magnitudes of signals compared to provide the ability to identify similar magnitudes, or, conversely, distinctly different magnitudes, as well as provide scoring regarding the similarity of the shapes of the signals.

### SUMMARY OF THE INVENTION

The present invention provides systems, methods and computer readable storage media for identifying, in a signal of interest, signal segments matching a reference signal segment. A processor coupled to memory is adapted to perform operations including: converting the reference signal segment to a first vector characterized by n pairs of data points, wherein n is an integer greater than zero and each pair of data points comprises a data point having a value along the first axis and a value along a second axis normal to the first axis. Segment of the signal of interest are converted to additional vectors, wherein each of the segments of the signal of interest has a first length in a direction along the first axis and has n pairs of data points. A correlation value is calculated between the reference signal segment and each of the segments of the signal of interest, using the first vector and the additional vectors, respectively. An estimation of the magnitude of the reference signal segment relative to at least a subset of the segments of the signal of interest for which correlation values have indicated relatively similar correlation is calculated. A result of the operations is outputted for use by a human user.

In at least one embodiment, the reference signal segment is a segment of the signal of interest.

In at least one embodiment, a display is coupled to the processor, wherein the outputting comprises outputting instructions causing a display to display an indication of the reference segment and at least a subset of the segments of the signal of interest, each having a correlation value within a predetermined correlation value range.

In at least one embodiment, the displaying of an indication includes displaying an indication of the reference signal segment and each of the segments of the signal of interest for which a correlation value has been calculated that is within a predetermined correlation value range, and for which an estimation of magnitude has been calculated to be at least one of: above a predetermined threshold value, or below a predetermined threshold value.

In at least one embodiment, the calculation of a correlation value comprises calculating a Pearson coefficient.

In at least one embodiment, the calculation of an estimation of the magnitude of the reference signal segment relative to at least a subset of the segments of the signal of interest for which correlation values have indicated relatively similar correlation comprises calculating a slope value of a linear regression between the first vector and each additional vector of the at least a subset, respectively.

In at least one embodiment, the calculation of an estimation of the magnitude of the reference signal segment relative to at least a subset of the segments of the signal of interest for which correlation values have indicated relatively similar correlation comprises calculating a y-intercept value of a linear regression between the first vector and each additional vector of the at least a subset, respectively.

In at least one embodiment, the system is further adapted for calculating a p-value for at least one of the correlation values.

In at least one embodiment, the signal of interest comprises data values representing a molecular weight of a protein.

In at least one embodiment, the signal of interest comprises an oscilloscope trace.

A computer-assisted method of identifying, in a signal of interest, signal segments matching a reference signal segment is provided, wherein the method includes: converting the reference signal segment to a first vector characterized by n pairs of data points, wherein n is an integer greater than zero and each pair of data points comprises a data point having a value along the first axis and a value along a second axis normal to the first axis; converting segments of the signal of interest to additional vectors, wherein each of the segments of the signal of interest has a first length in the direction along the first axis and has n pairs of data points; calculating a correlation value between the reference signal segment and each of the segments of the signal of interest, using the first vector and the additional vectors, respectively; calculating an estimation of the magnitude of the reference signal segment relative to at least a subset of the segments of the signals of interest for which correlation values have indicated relatively similar correlation; and outputting a result of the method for use by a human user.

In at least one embodiment, the reference signal segment is a segment of the signal of interest.

In at least one embodiment, the outputting includes outputting instructions causing a display to display an indication of the reference segment and at least a subset of the segments of the signal of interest, each having a correlation value within a predetermined correlation value range.

In at least one embodiment, the displaying of an indication includes displaying an indication of the reference signal segment and each of the segments of the signal of interest for which a correlation value has been calculated that is within a predetermined correlation value range, and for which an estimation of magnitude has been calculated to be one of: above a predetermined threshold value, or below a predetermined threshold value.

In at least one embodiment, the calculation of a correlation value comprises calculating a Pearson coefficient.

In at least one embodiment, the calculation of an estimation of the magnitude of the reference signal segment relative to at least a subset of the segments of the signal of interest for which correlation values have indicated relatively similar correlation comprises calculating a slope value of a linear regression between the first vector and each additional vector of the at least a subset, respectively.

In at least one embodiment, the calculation of an estimation of the magnitude of the reference signal segment relative to at least a subset of the segments of the signal of interest for which correlation values have indicated relatively similar correlation comprises calculating a y-intercept value of a linear regression between the first vector and each additional vector of the at least a subset, respectively.

In at least one embodiment, the p-value is calculated for at least one of the correlation values.

In at least one embodiment, the signal comprises data values representing a molecular weight of a protein.

In at least one embodiment, the signal comprises an oscilloscope trace.

A computer readable storage medium having stored thereon one or more sequences of instructions for identifying, in a signal of interest, signal segments matching a reference signal segment is provided, wherein execution of the one or more sequences of instructions by one or more processors causes the one or more processors to perform a process including: converting the reference signal to a first vector characterized by n pairs of data points, wherein n is an integer greater than zero and each pair of data points comprises a data point having a value along a first axis and a value along a second axis normal to the first axis, converting segments of the signal of interest to additional vectors, wherein each of the segments of the signal of interest has a first length in a direction along the first axis and has n pairs of data points; calculating a correlation value between the reference signal segment and each of the segments of the signal of interest, respectively; calculating an estimation of the magnitude of the reference signal segment relative to at least a subset of the segments of the signal of interest for which correlation values have indicated relatively similar correlation; and outputting a result of the process for use by a human user.

In at least one embodiment, the reference signal segment is a segment of the signal of interest.

In at least one embodiment, the outputting comprises displaying an indication of the reference segment and at least a subset of the segments of the signal of interest, each having a correlation value within a predetermined correlation value range.

In at least one embodiment, the displaying comprises displaying an indication of the reference signal segment and each of the segments of the signal of interest for which a correlation value has been calculated that is within a predetermined correlation value range, and for which an estimation of magnitude has been calculated to be one of: above a predetermined threshold value, or below a predetermined threshold value.

In at least one embodiment, the calculation of an estimation of the magnitude of the reference signal segment relative to at least a subset of the segments of the signal of interest for which correlation values have indicated relatively similar correlation comprises calculating a slope value of a linear regression between the first vector and each additional vector of the at least a subset, respectively.

In at least one embodiment, the calculation of an estimation of the magnitude of the reference signal segment relative to at least a subset of the segments of the signal of interest for which correlation values have indicated relatively similar correlation comprises calculating a y-intercept value of a linear regression between the first vector and each additional vector of the at least a subset, respectively.

In at least one embodiment, a p-value is calculated for at least one of the correlation values.

These and other features of the invention will become apparent upon reading the details of the systems, methods and computer readable media as more fully described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an example illustrating the usefulness of calculating a slope of a linear regression line to provide information about relative magnitudes of signals compared by the linear regression of vectors representing the signals.

FIG. 2 shows plots of two signals, each of which forms a substantially Gaussian signal shape.

FIG. 3 shows results of a linear regression performed on the signals shown in FIG. 2.

FIG. 4 shows the display of an interface of an embodiment of the present invention used to identify correlating protein profile signals.

FIGS. 5-6 illustrate an embodiment of the present invention used to identify correlating signal segments in a dense, time series graph.

FIG. 7 illustrates a typical computer system in accordance with an embodiment of the present invention.

### DETAILED DESCRIPTION OF THE INVENTION

Before the present systems, methods and computer readable storage media are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a slope” includes a plurality of such slopes and reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “overall ratio” or “overall relative ratio”, as used in describing the overall ratio between a reference and a match signal, refers to the relative magnitude of the reference signal to the match signal. This relative magnitude is a value in the direction along the axis of the plotted signal that is normal to the axis along which matched signals are being sought. Thus, for a time-series signal, the relative magnitude is measured along the axis orthogonal to the time axis. An estimated relative magnitude of the reference signal to the match signal can provide an estimate of the overall ratio between the reference and match signals by calculating a slope of the linear regression line calculated for the reference and the match signal.

A “shape” of a signal refers to its waveform, and is characterized by the degree of change in the value along one axis per unit value along the axis that is orthogonal to the one axis. The axis that is orthogonal, in this case, is the axis along which signals are being checked for matches.

### Systems, Methods and Computer Readable Storage Media

The present invention provides improved methods of correlation scoring over what is previously known, as well as systems and computer readable storage media configured to performing the methods. The methods described above in the background section are sometimes referred to as methods of performing local correlation. In addition to providing such correlation, the present invention further intelligently filters correlation results based on additional similarity attributes. The filtering is very efficient because it is based on the same sums required to compute the underlying correlation results, therefore very little additional computation is require to perform the filtering.

Pearson correlation can be used as the basic measure for correlation scoring according to the present invention, as a similarity measure to determine relative similarity of the shapes of the signals compared. The slope of a linear regression performed relative to the signals being compared can be used to estimate the overall ratio of the reference and match signals. By further taking into account the y-intercept of the regression line, this can also help to eliminate putative matches for which the relative magnitudes of the signals are substantially mismatched by a fixed offset (e.g. different baselines). These filters enable the system to compute a familiar similarity measure (i.e., Pearson Correlation) with a rigorous statistical interpretation, thereby allowing the user to filter out amplitude mismatches by a very intuitive and easy-to-understand mechanism.

Three values are commonly computed when performing linear regression, i.e., slope, intercept (y-axis intercept) and the Pearson coefficient. For two matched vectors x and y which are assumed to be linearly related by the equation y=mx+b, the slope m is computed according to the following:

$$m = \frac{n \sum ( x , y ) - \sum x \sum y }{n \sum ( {x}^{2} ) - {( \sum x )}^{2}} \qquad ( 1 )$$

where

n=the number of data points in each vector.

The intercept b is computed according to the following:

$$b = \frac{\sum y - m \sum x}{n} \qquad ( 2 )$$

The Pearson coefficient r is computed according to the following formula:

$$r = \frac{\sum ( xy ) - \frac{\sum x \sum y}{n} }{\sqrt{[ \sum ( {x}^{2} ) - \frac{{( \sum x )}^{2}}{n} ]} \sqrt{[ \sum ( {y}^{2} ) - \frac{{( \sum y )}^{2}}{n} ]}} \qquad ( 3 )$$

The number of degrees of freedom df is defined by:

df=n−2 (4)

Assuming the null hypothesis that the two vectors x and y are not correlated, the following statistic t can be defined:

$$t = r \sqrt{\frac{df}{1 - {r}^{2}}} \qquad ( 5 )$$

Where equation (5) is never a worse estimate for significance than more precise means, even for small n (e.g. <500).

For the null hypothesis, the values of t are distributed like a Student's t-distribution with df degrees of freedom. A p-value can be computed as:

$$p = B ( \frac{df}{df + {t}^{2}} ; \frac{df}{2} , \frac{1}{2} ) \qquad ( 6 )$$

where B is the incomplete beta function defined as:

B(x,a,b)=∫ₒ^{x}t^{a-1}(1−t)^{b-1}dt, (7)

for 0≦x≦1. In practice, numerical approximations are used to compute B, and a and b are mathematical parameters of the beta function. For example, in equation (6), a=df/2 and b=1/2.

The advantage of calculating the probability (i.e., “p value”) rather than simply relying upon the value of r is that the probability factors in the number of data points being considered (i.e., sample size “n”) and more accurately represents the confidence value, where the confidence value is a relative measure of how reliable is the conclusion that the correlation is significant. It also has a rigorous interpretation as a probability, as opposed to the more qualitative measure of correlation provided by the Pearson correlation coefficient r.

The Pearson correlation provides a good measure of whether or not the shapes of the signals being compared are similar. However, it does not relate any information about the relative magnitudes of the two signals being compared. In many instances, it is important to a user to know the relative magnitudes of signals being compared and/or to limit findings of matching signals from the set of signals compared with a reference signal to only those signals that are not only similar in shape, but similar in magnitude. The present invention uses the slope of the linear regression between two signals to infer information about the overall relative ratio of the two signals being compared.

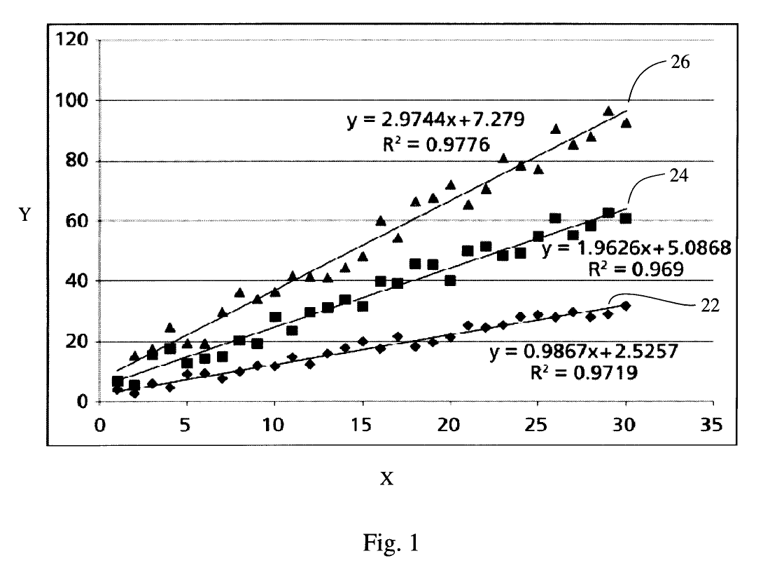

With reference to FIG. 1 an illustration and example of the usefulness of slope in providing information about relative magnitudes of signals compared is now described. Starting with a vector X defined as a vector containing the consecutive integers 1 through 30, i.e., X={1,2,3, . . . 29,30}, a second vector Y is defined by multiplying vector X, by a factor and also introducing some random perturbations, where Y=r and *5+Xi*m, where m=1,2,3, . . . , 29, 30 and r and=a random number between 0 and 1. The effect on a linear correlation plot is that this multiplier m will be reflected in the slope of the resulting regression lines as shown in FIG. 1.

FIG. 1 shows plots of the linear correlation plots computed for linear correlation between vector X and vector Y₁ (linear correlation plot 22), linear correlation between vector X and vector Y₂) (linear correlation plot 24) and linear correlation between vector X and vector Y₃ (linear correlation plot 26), where m=1 for vector Y₁, m=2 for vector Y₂ and m=3 for vector Y₃. Due to the random jitter introduced by the rand variable (as an effort to make this model data appear more like real, measured data), the slopes of the fitted lines 22, 24 and 26 are not perfectly matched to values of 1, 2 and 3, respectively, but are clearly close to those expected values. Thus, the slope of the regression line can be used to estimate the overall relative ratio between the signals being compared and correlated.

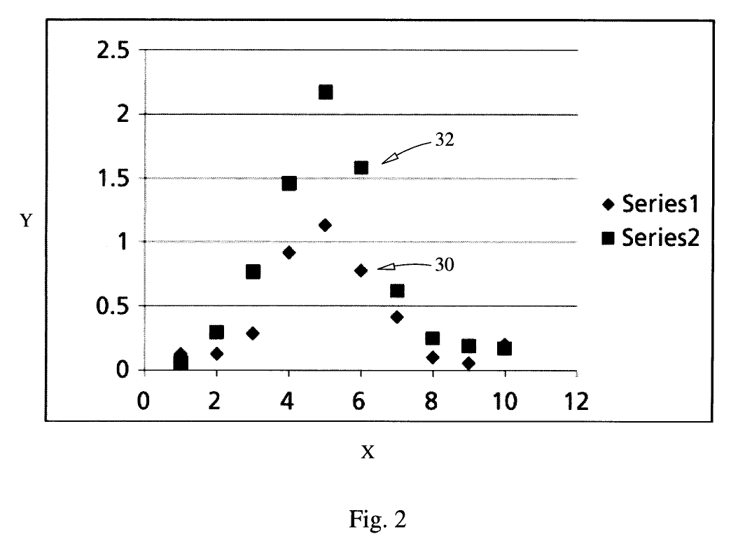

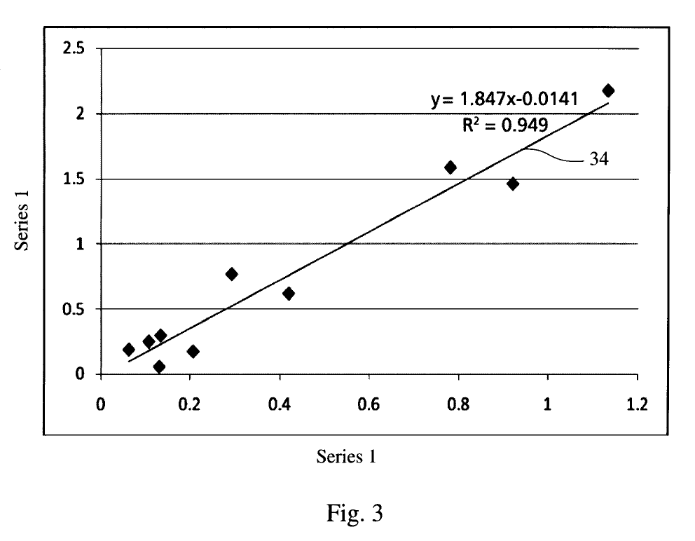

As another illustration of these principles, FIG. 2 shows plots of two signals (series of data points) X and Y (30 and 32 or Series 1 and Series 2, respectively), each of which forms a substantially Gaussian signal shape. In this example, the magnitude ratio between signals 32 and 30 is 2. Upon performing a linear regression on the two signals 30 and 32, the linear correlation plot 34 from the results of the linear regression are shown in FIG. 3. As expected, the calculated correlation is high, i.e., R²=0.949. The slope of line 34 is 1.847, which is considered to be reasonably close to the expected slope of 2. The example of FIGS. 2-3 has much more random jitter than the example of FIG. 1. However, even with this additional jitter, the slope of the regression line 34 still provides a reasonably good estimate of the relative magnitude ratio between the signals 32 and 30.

One of the applications of the present invention includes a computer-assisted method of identifying, in a signal of interest, signal segments matching a reference signal segment, where the signal of interest comprises molecular weight values and intensity values of a protein and signals of various proteins are analyzed with a goal of identifying protein interactions or protein complexes, for example. Commonly owned, copending application Ser. No. 12/011,347 filed Jan. 25, 2008 and titled “Exploratory Visualization of Protein Complexes by Molecular Weight” discloses a visualization system for analyzing protein interactions or protein complexes. Intact protein complexes are separated by a one-dimensional gel procedure and thin slices of the gel are processed by mass spectrum (MSIMS) analysis to identify and quantitate the individual proteins in each slice. By plotting the protein molecular weights versus the slice number, the results are then analyzed to look for proteins that are expected to belong to a single complex by the indication that these proteins have co-migrated and have produced a similar intensity profile across the range of slices. application Ser. No. 12/011,347 is hereby incorporated herein, in its entirety, by reference thereto.

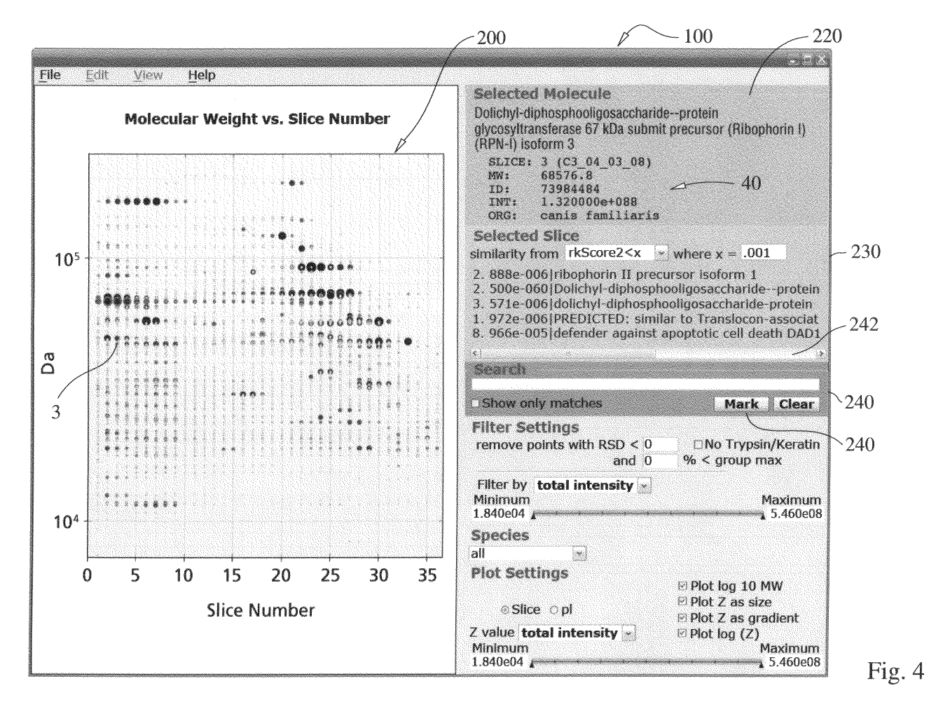

As noted above, the data resulting from the processing described above can be plotted in a plot 200 of molecular weight data values of the proteins versus the molecular weight ranges of the slices as illustrated on the display of the user interface 100 shown in FIG. 4. FIG. 4 illustrates a plot having units of the molecular weight data values on a Log₁₀ scale along the Y-axis of the plot versus the slice numbers on the X-axis. The Log₁₀ scale is optional, as a linear (or other log) scale could be employed, but the log scale keeps the plot 200 display compact and evenly distributed across a wide range of molecular weights. As noted, each individual slice represents a different range of molecular weights, so the X-axis could alternatively indicate the molecular weight ranges against which the molecular weights of the proteins are plotted. Accordingly, the molecular weight data values are plotted as molecular weights of the proteins (Y-Axis) versus molecular weights of the protein complexes (X-axis).

By plotting the molecular weights of the proteins versus slice number or molecular weights of the protein complexes, as illustrated in plot 200 of the visualization on user interface 100 in FIG. 4, the groupings of the proteins in each slice can be readily visualized by a user, making it much simpler to identify and explore putative protein members of a protein complex. The relative intensities of the mass data values can be displayed by varying the sizes of the indicators relative to the intensities of the mass data values represented thereby, as illustrated in FIG. 4. The user can readily visually observe regions in the plot 200 in FIG. 4 where the spots increase in size and intensity and then fade back to low intensity, when progressing from slice to slice.

Additionally, a pane 220 (captioned “Selected Molecule” in FIG. 4) is displayed on the user interface 100 that displays metadata 40 characterizing the molecule that a selected mass data value 3 represents. In FIG. 4, the user has selected an instance of riophrin I.

To aid in finding molecules of interest, a search mechanism 240 may also be provided on user interface 100. A search string can be entered by a user into the box 242, after which the user can either press the enter key on the keyboard of the computer system provided with the user interface 100 or mouse click on or otherwise select the “Mark” button 244 provided on the search mechanism pane 240. These actions cause all mass data values having characteristics matching the search string to be identified with a visual indicator that is distinct from all visual indications of mass data values that do not have characteristics matching the search string.

The system can be configured to compare migration patterns of protein molecules, where a migration pattern is defined by a vector of intensity values of a protein molecule across slices. When the migration patterns of two or more proteins are occurring in at least a predefined number of the same slices and have a similarity value greater than or equal to a predefined similarity threshold minimum value, then these proteins are identified as being putative members of the same protein complex and are displayed on the user interface for review by a user. It should be noted here that intensity can be used as an approximate surrogate measure of protein abundance.

Thus, similarity between protein intensity vectors can be computed according to the present invention to identify not only similarly shaped protein intensity vectors, but also protein intensity vectors of similar magnitude. As noted above, Pearson correlation can be used to identify similarly shaped vectors, with linear regression and calculation of the slope of the linear regression line being used to establish an estimate of the magnitude ratio between vectors that are compared.

In FIG. 4, the user has employed user interface 100 to search for all profiles that are locally correlated and that meet the filtering criteria:
1. Window size—include slices that are ±5 slices from the selected slice. (In this example, the selected slice was slice 3)
2. The relative fold ratio is less than 2.5×.
3. The y-intercept is not used for filtering.
4. The p-value is <0.001 (low values are highly correlated).
   The filtering criteria are specified on the interface 100. The criteria are shown in the “Selected Slice” panel 230 where it reads (across a couple of different user interface components) “similarity from rkScore2<x where x=0.001”.

Each profile meeting the filtering criteria forms a vector for comparison. Each vector comprises a molecular weight in the Y dimension of the plot. This gives rise to a horizontal “profile” spread across the X dimension of the plot. In this case the X dimension is the slice number that corresponds to a different molecular weight range. Pair wise comparisons are performed between two “profiles” (vectors) defined for two different Y-axis molecular weights. The actual correlation is computed between the measured intensities (represented in display 200 by relative size and color as a representation of a Z-axis of the graph.

The matched proteins that meet the above filter criteria are shown in pane 230 of FIG. 4, and are reproduced in the table below for readability:

TABLE

| p-value | Identified Protein |
|---|---|
| 2.88e−006 | Ribophorin II precursor isoform 1 |
| 2.500e−060 | Dolichyl-diphosphooligosaccharide-protein |
| | glycosyltransferase 67 kDA subunit |
| | precursor (Ribophorin I) (RPN-I) isoform 3 |
| 3.571e−006 | Dolichyl-diphosphooligosaccharide-protein |
| | glycosyltransferase OST48 |
| 1.972e−006 | PREDICTED: similar to Translocon- |
| | associated protein, delta subunit precursor |
| | (TRAP-delta) (Signal sequences receptor |
| | delta subunit) (SSR-delta) isoform 1 |
| 8.966e−005 | defender against apoptotic cell death DAD1 |

It is noted that ribophorin I, ribophorin II, OST 48 and DADI are all known to be members of the oligosaccharyl tansferase (OST) protein complex.

Thus, the above embodiment regarding FIG. 4 shows that the present invention can be used to reliably identify proteins with similar profiles, such as clusters of similar profiles, based not only similar profile shapes, but also similar profile magnitudes, to identify or infer proteins that might be in a complex. Another approach is to start with a protein that is a known member of a complex, and compare the profile of this protein (e.g., intensity profile, as described above) with other proteins to find profiles having similar shape and magnitude, inferring proteins that might be associated with the known protein in the complex. Further, the correlation measures described can be used to find de novo one or more groups of proteins that appear to belong in one or more clusters. Accordingly, the present techniques do not need to rely upon having prior knowledge of canonical profiles, such as profiles that define a pattern expected for a particular cellular location.

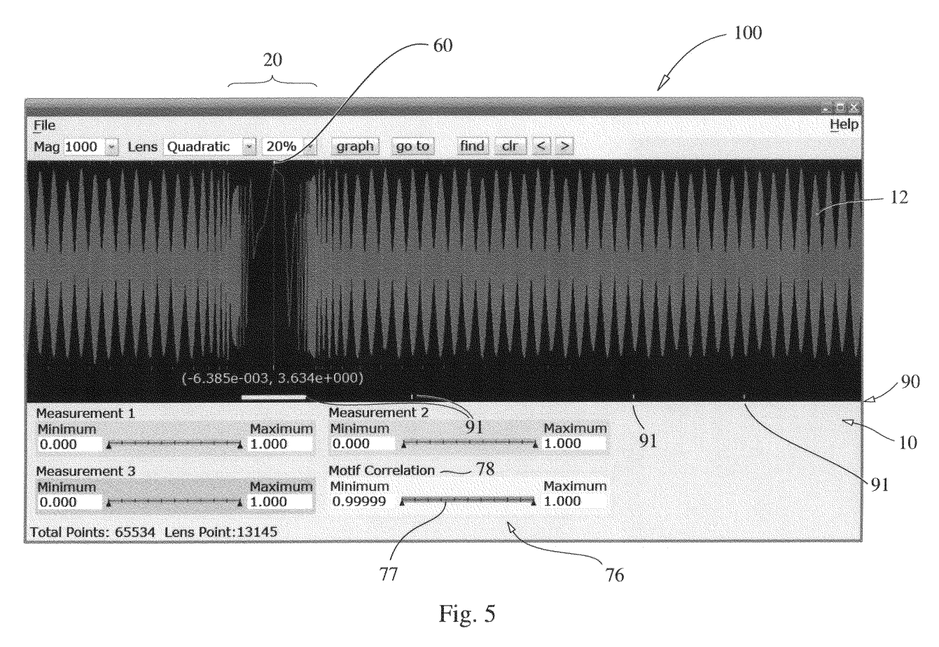

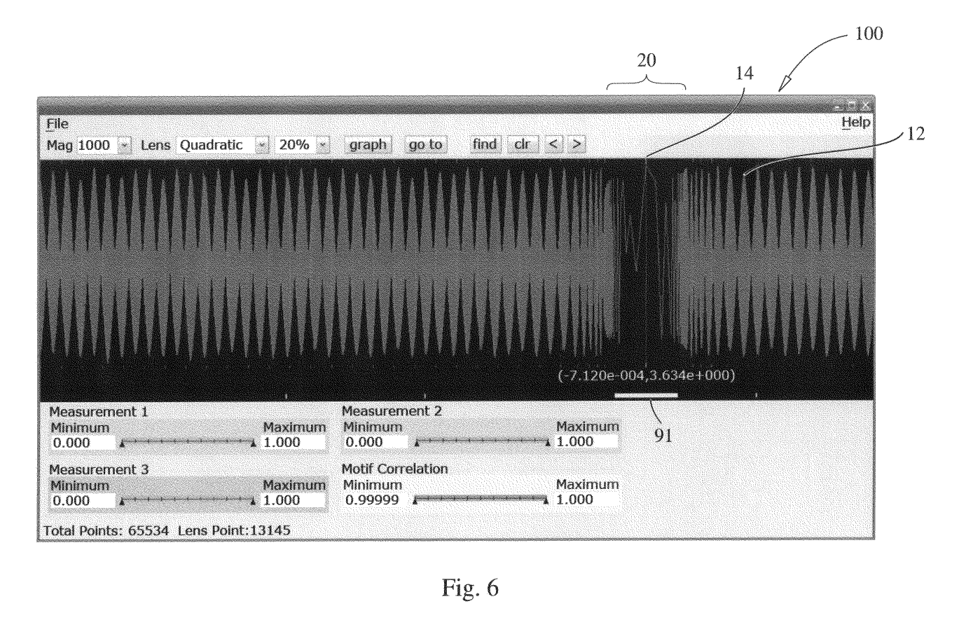

Another application of the present invention is to signal motif searching to find signals that have similar shape and to identify the relative magnitudes of the similarly shaped signals to a reference signal. FIGS. 5-6 are referred to in describing application of the present invention to a computer-assisted method of identifying, in a signal of interest, signal segments matching a reference signal segment, where the signal of interest is an oscilloscope trace.

FIG. 5 shows a stored oscilloscope trace being displayed by user interface 100 configured to manipulate oscilloscope trace data with features described in commonly owned, co-pending Application serial number (Application serial number not yet assigned, Attorney's Docket number 20080512-01) filed concurrently herewith and titled “Systems and Methods for Focus Plus Context Viewing of Dense, Ordered Line Graphs”. Application serial number (Application serial number not yet assigned, Attorney's Docket number 20080512-01) is hereby incorporated herein, in its entirety, by reference thereto.

User interface 100 in FIG. 5 displays a dense, time series graph 12 (in this case an amplitude modulated (AM) signal generated by an Agilent demonstration board) displayed on the display 10 of user interface 100. The Y-axis of the graph 12 is valued in measured voltage and the X-axis is the time axis. The carrier frequency of the signal displayed as graph 12 is 2 MHz. The open area 20 reveals a local magnification of the signal 12. The signal contains a “glitch” or anomaly 60 that is not expected and which deviates from the expected pattern of the waveform.

The segment of the signal contained within open portion 20 is selected as the reference signal segment and the remainder of the graph (trace) 12 is searched for each possible time point to identify if there are segments that are similar to the reference signal segment. As in the above examples, similarity is measure by computing the Pearson correlation between the reference signal segment and each other signal segment that is being compared. The other segments each have a length defined by 21 data points (window of 21 data points) as selected by the user when setting the length of the reference signal segment. This is described in greater detail in Application serial number (Application serial number not yet assigned, Attorney's Docket number 20080512-01) filed concurrently herewith and titled “Systems and Methods for Focus Plus Context Viewing of Dense, Ordered Line Graphs”. Of course, the invention is not limited to this length as the window size may be arbitrarily set by the user to any number of data points desired. Nor is the present invention limited to time-series graphs.

Upon calculating Pearson correlation, a linear regression is also calculated for the reference signal segment and each other segment that is being correlated, respectively. The slope is also calculated to give some idea of the relative magnitude between the two signals compared, and the y-intercept is also determined. In this case, thresholds were set requiring the slope to be within the interval of 0.5 and 2 (corresponding to a 2× magnitude ratio) to be considered a similar motif or similar signal segment to that of the reference signal segment. It is noted that the threshold levels for qualifying a similar magnitude (slope) may be varied and may be user settable. Also, the intercept in this example was required to be between −1 and 1 in order to qualify the segment as similar in magnitude. The y-intercept, for equal magnitude signals that are matched, should theoretically be zero. Accordingly, the y-intercept is another useful tool for filtering similarity results to those that have not only similar shape, but also similar magnitude. Note that in this case, the user is interested in signal segments that are very closely matching and therefore the slope thresholds (tolerance) is more stringent than the proteins example of FIG. 4.

Signal segments that are similar not only in shape, but also in magnitude are identified according to the filter set as “Motif Correlation” 78 in the measurement selection feature 76 in FIG. 5. The slider 77 is set to the interval 0.99999 to 1.0000. In this example, the value of 1-p is considered, and a value near 1 represents a good correlation. Accordingly, this filter has been set very stringently so that the identified signal segments can be considered to be extremely closely correlated. Matches, i.e., those that pass the filters and are expected to be well-correlated signal segments, are identified by track marks 91 in track 90 under the graph 12 at the time locations where the matches occur.

FIG. 6 shows an example where the user has navigated to one of the other track locations 90, by sliding the cursor 14 until it aligns with the other track 90 at the desired location, where the system opens that location 20. The user can visually inspect the magnified portion of the graph 12 in the newly opened location 20 and readily see that this segment is indeed very similar in shape and magnitude to the reference signal.

Although the examples described above use the standard definition of the Pearson coefficient for calculation Pearson correlation, it is possible to extend the concepts of the present invention to other types of correlation calculations. For example, it is possible to weight the contribution of each data point in the reference vector and the vectors generated from the matching segments. This weighting can be according to distance from a central data point location in each segment, or by measures of the variance of the data points being matched. Further alternatively, weighting can be performed by using confidence statistics generated by the MS/MS analysis used to identify proteins and their abundance.

Another alternative of the present invention includes extending the method to multiple regression. For example, using multiple regression, a measure of correlation of a group of putative protein complex members may be calculated, rather than just ranking the proteins by pair-wise correlation to a reference protein. Likewise, multiple regression can be used for mixed signal analysis to determine dynamic features of a signal such as rise and fall characteristics, as well as peak spacing. Each of these characteristics maps to a characteristic signal shape that can be matched using the correlation measurements described herein.

The present invention can also be applied to correlation analysis of sub-cellular fractionation components to extract similar fraction profiles, in like manner to the methods for identifying proteins of a protein complex described above.

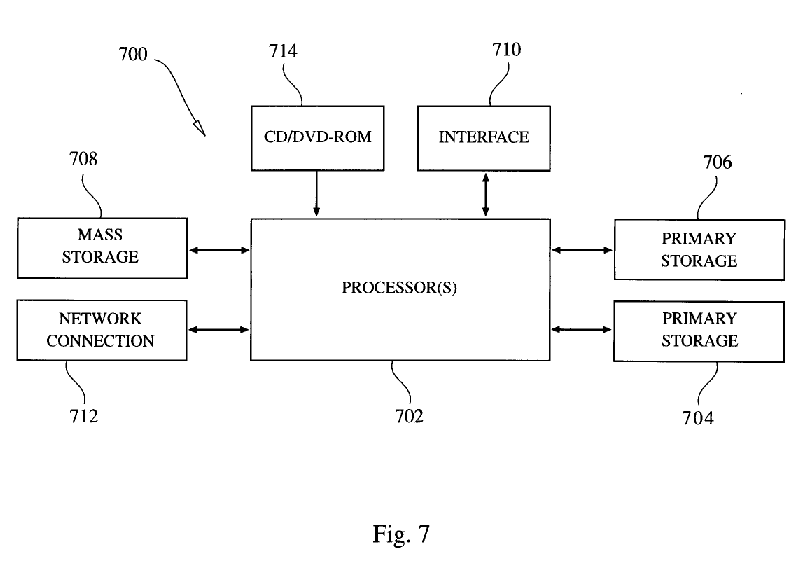

FIG. 7 illustrates a typical computer system in accordance with an embodiment of the present invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). As is well known in the art, primary storage 704 acts to transfer data and instructions unidirectionally to the CPU and primary storage 706 is used typically to transfer data and instructions in a bi-directional manner. Both of these primary storage devices may include any suitable computer-readable storage media such as those described above. A mass storage device 708 is also coupled bi-directionally to CPU 702 and provides additional data storage capacity and may include any of the computer-readable media described above. It is noted here that the terms “computer readable media” “computer readable storage medium” “computer readable medium” and “computer readable storage media”, as used herein, do not include carrier waves or other forms of energy, per se. Mass storage device 708 may be used to store programs, data and the like and is typically a secondary storage medium such as a hard disk that is slower than primary storage. It will be appreciated that the information retained within the mass storage device 708, may, in appropriate cases, be incorporated in standard fashion as part of primary storage 706 as virtual memory. A specific mass storage device such as a CD-ROM or DVD-ROM 714 may also pass data uni-directionally to the CPU.

CPU 702 is also coupled to an interface 710 that includes user interface 100, and which may include one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. CPU 702 optionally may be coupled to a computer or telecommunications network using a network connection as shown generally at 712. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for calculating correlation measurements, linear regression, slopes, intercepts, p-values, etc., instructions for plotting graphs, tracks, results, etc. on a display of the user interface, and other instructions may be stored on mass storage device 708 or 714 and executed on CPU 708 in conjunction with primary memory 706.

While the present invention has been described with reference to the specific embodiments thereof, it should be understood that various changes may be made and equivalents may be substituted without departing from the scope of the invention. In addition, many modifications may be made to adapt a particular situation, material, composition of matter, process, process step or steps, to the objective and scope of the present invention. All such modifications are intended to be within the scope of the claims appended hereto.

I claim:

1. A system for identifying, in a signal of interest, signal segments matching a reference signal segment, the system comprising:
a processor coupled to memory, and adapted to perform operations comprising:
converting said reference signal segment to a first vector characterized by n pairs of data points, wherein n is an integer greater than zero and each pair of data points comprises a data point having a value along the first axis and a value along a second axis normal to the first axis;
converting segments of said signal of interest to additional vectors, wherein each of said segments of said signal of interest has a first length in a direction along the first axis and has n pairs of data points;
calculating a correlation value between said reference signal segment and each of said segments of said signal of interest, using said first vector and said additional vectors, respectively;
calculating an estimation of the magnitude of said reference signal segment relative to at least a subset of said segments of said signal of interest for which correlation values have indicated relatively similar correlation; and
outputting a result of said operations for use by a human user.

2. The system of claim 1, wherein said reference signal segment is a segment of said signal of interest.

3. The system of claim 1 including a display coupled to said processor, wherein said outputting comprises outputting instructions causing a display to display an indication of said reference segment and at least a subset of said segments of said signal of interest each having a correlation value within a predetermined correlation value range.

4. The system of claim 3, wherein said displaying an indication comprises displaying an indication of said reference signal segment and each of said segments of said signal of interest for which a correlation value has been calculated that is within a predetermined correlation value range, and for which an estimation of magnitude has been calculated to be at least one of above a predetermined threshold value, or below a predetermined threshold value.

5. The system of claim 1, wherein said calculating a correlation value comprises calculating a Pearson coefficient.

6. The system of claim 1, wherein said calculating an estimation of the magnitude of said reference signal segment relative to at least a subset of said segments of said signal of interest for which correlation values have indicated relatively similar correlation comprises calculating a slope value of a linear regression between said first vector and each said additional vector of said at least a subset, respectively.

7. The system of claim 1, wherein said calculating an estimation comprises calculating a y-intercept value of a linear regression between said first vector and each said additional vector of said at least a subset, respectively.

8. The system of claim 1, wherein said operations additionally comprise calculating a p-value for at least one of said correlation values.

9. The system of claim 1, wherein said signal of interest comprises data values representing a molecular weight of a protein.

10. The system of claim 1, wherein said signal of interest comprises an oscilloscope trace.

11. A computer-assisted method of identifying, in a signal of interest, signal segments matching a reference signal segment, said method comprising:
converting said reference signal segment to a first vector characterized by n pairs of data points, wherein n is an integer greater than zero and each pair of data points comprises a data point having a value along the first axis and a value along a second axis normal to the first axis;
converting segments of said signal of interest to additional vectors, wherein each of said segments of said signal of interest has a first length in said direction along said first axis and has n pairs of data points;
calculating a correlation value between said reference signal segment and each of said segments of said signal of interest using said first vector and said additional vectors, respectively;
calculating an estimation of the magnitude of said reference signal segment relative to at least a subset of said segments of said signals of interest for which correlation values have indicated relatively similar correlation; and
outputting a result of said method for use by a human user.

12. The method of claim 11, wherein said reference signal segment is a segment of said signal of interest.

13. The method of claim 11, wherein said outputting comprises displaying an indication of said reference segment and at least a subset of said segments of said signal of interest each having a correlation value within a predetermined correlation value range.

14. The method of claim 13, wherein said displaying an indication comprises displaying an indication of said reference signal segment and each of said segments of said signal of interest for which a correlation value has been calculated that is within a predetermined correlation value range, and for which an estimation of magnitude has been calculated to be at least one of: above a predetermined threshold value, or below a predetermined threshold value.

15. The method of claim 11, wherein said calculating a correlation value comprises calculating a Pearson coefficient.

16. The method of claim 11, wherein said calculating an estimation comprises calculating a slope value of a linear regression between said first vector and each said additional vector of said at least a subset, respectively.

17. The method of claim 11, wherein said calculating an estimation comprises calculating a y-intercept value of a linear regression between said first vector and each said additional vector of said at least a subset, respectively.

18. The method of claim 11, further comprising calculating a p-value for at least one of said correlation values.

19. The method of claim 11 wherein said signal comprises data values representing a molecular weight of a protein.

20. The method of claim 11, wherein said signal comprises an oscilloscope trace.

21. A computer readable storage medium having stored thereon one or more sequences of instructions for identifying, in a signal of interest, signal segments matching a reference signal segment, wherein execution of the one or more sequences of instructions by one or more processors causes the one or more processors to perform a process comprising:
converting said reference signal to a first vector characterized by n pairs of data points, wherein n is an integer greater than zero and each pair of data points comprises a data point having a value along a first axis and a value along a second axis normal to the first axis;
converting segments of said signal of interest to additional vectors, wherein each of said segments of said signal of interest has a first length in a direction along the first axis and has n pairs of data points.
calculating a correlation value between said reference signal segment and each of said segments of said signal of interest, respectively;
calculating an estimation of the magnitude of said reference signal segment relative to at least a subset of said segments of said signal of interest for which correlation values have indicated relatively similar correlation; and
outputting a result of said process for use by a human user.

22. The computer readable storage medium of claim 21, wherein said reference signal segment is a segment of said signal of interest.

23. The computer readable storage medium of claim 21, wherein said outputting comprises outputting instructions causing a display to display an indication of said reference segment and at least a subset of said segments of said signal of interest, each having a correlation value within a predetermined correlation value range.

24. The computer readable storage medium of claim 23, wherein said displaying comprises displaying an indication of said reference signal segment and each of said segments of said signal of interest for which a correlation value has been calculated that is within a predetermined correlation value range and for which an estimation of magnitude has been calculated to be at least one of: above a predetermined threshold value, or below a predetermined threshold value.

25. The computer readable storage medium of claim 21, wherein said calculating an estimation of the magnitude comprises calculating a slope value of a linear regression between said first vector and each said additional vector of said at least a subset, respectively.

26. The computer readable storage medium of claim 21, wherein said calculating an estimation of the magnitude comprises calculating a y-intercept value of a linear regression between said first vector and each said additional vector of said at least a subset, respectively.

27. The computer readable storage medium of claim 21, wherein execution of the one or more sequences of instructions by the one or more processors causes the one or more processors to further perform:
calculating a p-value for at least one of said correlation values.
